(19) United States
(12) Patent Application Publication
(10) Pub. No.: US 2023/0237138 A1
(43) Pub. Date: Jul. 27, 2023

(54) SYSTEM AND METHODS FOR USER AUTHENTICATION AFTER FAILED ATTEMPTS

(71) Applicant: Zinatt Technologies Inc., Indianapolis, IN (US)

(72) Inventors: Gabriel E. Reina, Tucson, AZ (US); Thomas R. Hershberger, Indianapolis, IN (US)

(21) Appl. No.: 17/902,567

(22) Filed: Sep. 2, 2022

Related U.S. Application Data
(60) Provisional application No. 63/302,367, filed on Jan. 24, 2022.

(51) Int. Cl. G06F 21/34; G06F 21/45

(52) U.S. Cl. CPC G06F 21/34; G06F 21/45

(57) ABSTRACT

Systems and methods for user authentications. In some embodiments, the systems are configured to perform operations including: receiving and declining one or more attempts for authentication from a user device, transmitting to and causing the user device to display a code, receiving an authentication request associated with the code being scanned, collecting one or more properties associated with one or more user devices, evaluating an audit trail to generate an evaluation result, and transmitting a notification to the user device based at least in part on the evaluation result.

### CROSS-REFERENCE TO RELATED APPLICATIONS

The present application claims priority to U.S. Provisional Application No. 63/302,367, filed Jan. 24, 2022, the complete disclosure of which is expressly incorporation by reference here in its entirety.

### TECHNICAL FIELD

This disclosure relates to systems and methods for user authentication. More specifically, this disclosure relates to systems and methods for user authentication after multiple failed attempts or where users have at least one previous successful login.

### BACKGROUND

Current methods of user authentication include verification of a username and a corresponding password at time of login. Upon multiple failed attempts, the system would typically lock down the account temporarily and/or issue request for resetting the password associated with the account. Such temporary lockdown or mandatory change of password usually creates inconvenience and inefficiency on the user’s end. In addition, users typically need to re-enter their username and password even though they have successfully logged in on a certain device.

A need therefore exists for a more efficient way of login after multiple failed attempts or where users have at least one previous successful login.

### SUMMARY

Systems and methods disclosed herein allow for a more efficient way of login, especially in cases where the user had multiple failed attempts of logging in (e.g., incorrect username and/or password) or where users have at least one previous successful login.

In Example 1, a system comprises one or more memories having instructions stored thereon, and one or more processors configured to execute the instructions and perform operations. The operations comprise receiving, from a first user device, one or more attempts for authentication; declining the one or more attempts for authentication; transmitting a code to the first user device; causing the first user device to display the code; receiving an authentication request, the authentication request being initiated by a second user device scanning the code, the second user device being different from the first user device; collecting one or more properties associated with at least one selected from a group consisting of the first user device and the second user device, evaluating an audit trail using the collected one or more properties to generate an evaluation result; and transmitting a notification to the first user device based at least in part on the evaluation result.

In Example 2, the system of Example 1 further comprises receiving a scanned code from the second user device, the scanned code being generated by the second user device.

In Example 3, the system of Example 1, wherein the evaluating the audit trail comprises one or more verifications of one or more properties associated with at least one selected from a group consisting of the first user device and the second user device.

In Example 4, the system of Example 3, wherein the one or more properties comprise a shared property of the first user device and the second user device.

In Example 5, the system of Example 4, wherein the operations further comprise receiving a first verification information on the shared property of the first user device; and evaluating the audit trail based on the first verification information.

In Example 6, the system of Example 4, wherein the operations further comprise receiving a second verification information on the shared property of the second user device; and evaluating the audit trail based on the second verification information.

In Example 7, the system of Example 3, wherein the one or more properties comprise at least one selected from a group consisting of a first unique property of the first user device and a second unique property of the second user device.

In Example 8, the system of Example 7, wherein the operations further comprise receiving a third verification information on the first unique property of the first user device; and evaluating the audit trail based on the third verification information.

In Example 9, the system of Example 3, wherein the one or more verifications comprise four or more verifications, wherein the operations further comprise generating a positive evaluation result if at least a predetermined number of the one or more verifications are positive.

In Example 10, the system of Example 9, wherein the one or more verifications are conducted in sequence, wherein the operations further comprise generating a negative evaluation result if a current verification is negative.

In Example 11, the system of Example 3, wherein the evaluating the audit trail comprises comparing the one or more properties associated with at least one selected from a group consisting of the first user device and the second user device to one or more property records stored in the one or more memories.

In Example 12, the system of Example 2, wherein the evaluation result is further generated based on evaluating the audit trail.

In Example 13, the system of Example 1, wherein the transmitted notification comprises granting an access if the evaluation result is positive.

In Example 14, the system of Example 1, wherein the operations further comprise receiving one or more properties associated with the first user device; and evaluating an audit trail based on the one or more properties associated with the first user device.

In Example 15, the system of Example 14, wherein the one or more properties associated with the first user device include at least one selected from a group consisting of an internet protocol (IP) address, a device identification number, cached data, and a device type.

In Example 16, the system of Example 14, wherein the one or more properties associated with the first user device include at least one selected from a group consisting of a phone number, an International Mobile Equipment Identity (IMEI) number, a Mobile Equipment Identifier (MEID) number, and a phone model identification number.

In Example 17, the system of Example 1, wherein the transmitted code expires after a period of time.

In Example 18, the system of Example 1, wherein the code is a quick reference (QR) code.

In Example 19, the system of Example 1, wherein the second user device comprises a camera configured to scan the code.

In Example 20, the system of Example 1, wherein each attempt of the one or more attempts comprises a request for entering a username and a password.

In Example 21, the system of Example 1, wherein the code is randomly selected from a plurality of codes stored in the one or more memories.

In Example 22, the system of Example 1, wherein after receiving the scanned code, the one or more processors is configured to set a time limit within which the evaluation result is generated.

In Example 23, a system comprises one or more memories having instructions stored thereon, and one or more processors configured to execute the instructions and perform operations. The operations comprise receiving, from a first user device, a request for smart entry; granting the request for smart entry; transmitting a code to the first user device; causing the first user device to display the code; receiving an authentication request, the authentication request being initiated by a second user device scanning the code, the second user device being different from the first user device; collecting one or more properties associated with at least one selected from a group consisting of the first user device and the second user device; evaluating an audit trail using the collected one or more properties to generate an evaluation result; and transmitting a notification to the first user device based at least in part on the evaluation result.

In Example 24, the system of Example 23, wherein granting the request for smart entry comprises transmitting a question about user profile information to the first user device; causing the first user device to display the question; receiving an answer to the question; and evaluate the answer based on user profile information stored in the one or more memories.

In Example 25, the system of Example 24, wherein the question about user profile information is randomly selected from a plurality of questions about user profile information.

In Example 26, a system comprises a first user device and a second user device. The first user device is configured to submit one or more attempts for authentication to one or more processors; receive declines of the one or more attempts from the one or more processors; receive a code for authentication; and display the code for authentication. The second user device is configured to scanning the code displayed by the first user device; in response to scanning the code, initiating an authentication request; and submitting the authentication request to an authentication device. In some embodiments, the authentication device is configured to evaluate an audit trail associated with the authentication request and generate an evaluation result. In some embodiments, the first user device is configured to receive a notification indicative of the evaluation result. In some embodiments, the first user device is different from the second user device.

In Example 27, the system of example 26, wherein the second user device is further configured to generate a scanned code; and submit the scanned code to one or more processors.

In Example 28, the system of example 26, wherein the evaluating the audit trail comprises one or more verifications of one or more properties associated with at least one selected from a group consisting of the first user device and the second user device.

In Example 29, the system of example 28, wherein the one or more properties comprise a shared property of the first user device and the second user device.

In Example 30, the system of example 29, wherein the authentication device is configured to receive a first verification information on the shared property of the first user device; and evaluate the audit trail based on the first verification information.

In Example 31, the system of example 30, wherein the authentication device is further configured to receive a second verification information on the shared property of the second user device; and evaluate the audit trail based on the second verification information.

In Example 32, the system of example 28, wherein the one or more properties comprise at least one selected from a group consisting of a first unique property of the first user device and a second unique property of the second user device.

In Example 33, the system of example 32, wherein the authentication device is configured to receive a third verification information on the first unique property of the first user device; and evaluate the audit trail based on the third verification information.

In Example 34, the system of example 28, wherein the one or more verifications comprises four or more verifications, wherein the authentication device is further configured to generate a positive evaluation result if at least a predetermined number of the one or more verifications are positive.

In Example 35, the system of example 34, wherein the one or more verifications are conducted in sequence, wherein the authentication device is further configured to generate a negative evaluation result if a current verification is negative.

In Example 36, the system of example 28, wherein the evaluating the audit trail comprises comparing the one or more properties associated with at least one selected from a group consisting of the first user device and the second user device to one or more property records stored in the one or more memories.

In Example 37, the system of example 27, wherein the evaluation result is further generated based on evaluating the audit trail.

In Example 38, the system of example 26, wherein the received notification comprises being granted an access if the evaluation result is positive.

In Example 39, the system of example 26, wherein the authentication device is further configured to receive one or more properties associated with the first user device; and evaluate an audit trail based on the one or more properties associated with the first user device.

In Example 40, the system of example 39, wherein the one or more properties associated with the first user device include at least one selected from a group consisting of an internet protocol (IP) address, a device identification number, cached data, and a device type.

In Example 41, the system of example 39, wherein the one or more properties associated with the first user device include at least one selected from a group consisting of a phone number, an International Mobile Equipment Identity (IMEI) number, a Mobile Equipment Identifier (MEID) number, and a phone model identification number.

In Example 42, the system of example 26, wherein the displayed code expires after a period of time.

In Example 43, the system of example 26, wherein the code is a quick reference (QR) code.

In Example 44, the system of example 26, wherein the second user device comprises a camera configured to scan the code.

In Example 45, the system of example 26, wherein each attempt of the one or more attempts comprises a request for entering a username and a password.

In Example 46, the system of example 26, wherein the code is randomly selected from a plurality of codes stored in one or more memories of the authentication device.

In Example 47, the system of example 26, wherein after receiving the scanned code, the one or more processors is configured to set a time limit within which the evaluation result is generated.

In Example 48, a method of authentication allowing one or more attempts is implemented by a system including one or more processors and one or more memories. The method comprises receiving, from a first user device, one or more attempts for authentication; declining the one or more attempts for authentication; transmitting a code to the first user device; causing the first user device to display the code; receiving an authentication request, the authentication request being initiated by a second user device scanning the code, the second user device being different from the first user device; collecting one or more properties associated with at least one selected from a group consisting of the first user device and the second user device; evaluating an audit trail using the collected one or more properties to generate an evaluation result; and transmitting a notification to the first user device based at least in part on the evaluation result.

In Example 49, a method of authentication allowing one or more attempts comprises submitting, by a first user device, one or more attempts for authentication; receiving, by the first user device, declines to the one or more attempts; receiving, by the first user device, a code for authentication; displaying, by the first user device, the code for authentication; scanning, by a second user device, the code displayed by the first user device; in response to scanning the code, initiating, by the second user device, an authentication request; and receiving, by the first user device, a notification indicating an evaluation result, wherein the evaluation result is generated by evaluating an audit trail associated with the authentication request. In some embodiments, the first user device is different from the second user device.

### BRIEF DESCRIPTION OF THE DRAWINGS

The above mentioned and other features and objects of this disclosure, and the manner of attaining them, will become more apparent and the disclosure itself will be better understood by reference to the following description of an embodiment of the disclosure taken in conjunction with the accompanying drawings, wherein:

FIG. 1 is an illustrative system diagram for user authentication according to various embodiments;

FIG. 2 is a simplified diagram illustrating a user authentication system according to various embodiments;

FIG. 3 shows some examples of properties associated with various user devices used for an authentication method according to various embodiments;

FIG. 4 is an illustrative system diagram for user authentication according to various embodiments;

FIG. 5 is an illustrative system diagram for user authentication according to various embodiments;

FIG. 6 is an example flow diagram of authentication including a one or more failed attempts, according to various embodiments;

FIG. 7 is another example flow diagram of authentication including a one or more failed attempts, according to various embodiments.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates an embodiment of the disclosure, in one form, and such exemplifications are not to be construed as limiting the scope of the disclosure in any manner.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

As used herein, the term “based on” or “based upon” is not meant to be restrictive, but rather indicates that a determination, identification, prediction, calculation, and/or the like, is performed by using, at least, the term following “based on” or “based upon” as an input. For example, predicting an outcome based on a particular piece of information may additionally, or alternatively, base the same determination on another piece of information.

User authentication methods may include verification of a username and a corresponding password at time of login during an authentication session. Upon multiple failed attempts of login during one or more previous sessions, the system might lock down the account temporarily and/or issue request for resetting the password associated with the account. Such temporary lockdown or mandatory change of password usually creates inconvenience and inefficiency to the user. As used herein, an attempt refers to a user’s request to log into a secured system through a verification method, and a verification refers to verifying one or more credentials (e.g., username, user biometric data, user characteristics, user device properties, etc.) associated with the user’s request for login, for example, against records of the specific user. Some embodiments of the present disclosure describe a system having one or more processors configured to use information of a user device to verify (the user’s login attempt.

Some embodiments of the present disclosure describe a system having one or more processors configured to transmit a code to a user device after receiving and declining one or more attempts for authentication to access a system from the user device. As used herein, a code refers to a machine-readable optical label associated with certain information. For example, a code includes a one-dimensional code (e.g., barcode), a two-dimensional code (e.g., a quick reference (QR) code), a three-dimensional code (e.g., a code including a third characteristic such as a color, a time). In some examples, a code (e.g., a QR code) contains an address (e.g., a website address) of a relevant service (e.g., a web service configured to collect information). As used herein, an address refers to a network interface address (e.g., a Uniform Resource Locator (URL), an IP address). Upon scanning the code and reaching the address, a user authentication system collects one or more properties associated with the user (e.g., user location, user device properties) used to scan the code and verifies the one or more properties of the user to grant or deny access to the system.

In embodiments where the user had at least one successful login during one or more previous sessions, a smart token (i.e., a unique key value) may be stored on the user’s device after the first successful login. As used herein, a smart token is a file hidden somewhere on the device used for login (i.e., hard to access or delete by the user), and may be a unique alpha numeric value. The use of a smart token stored from a previous login session may serve as an additional layer of security for user authentication during a current login session.

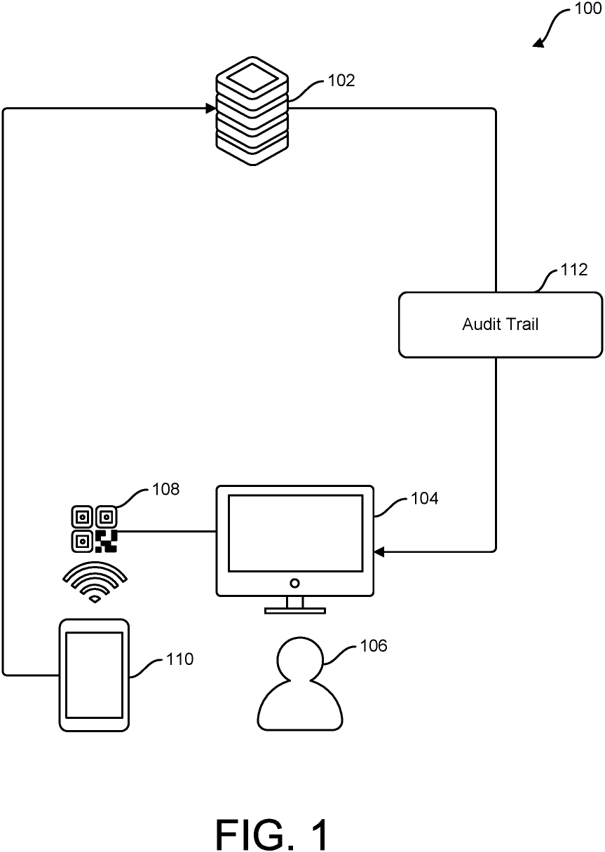

FIG. 1 illustrates a user authentication system 100 according to various embodiments. FIG. 1 is merely an example. One of ordinary skill in the art would recognize many variations, alternatives, and modifications. According to certain embodiments, the user authentication system 100 includes an authentication device 102, a first user device 104, and a second user device 110. Although the above has been shown using a selected group of components for the authentication system 100, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some embodiments, the user authentication system 100 includes an authentication device 102 including one or more memories having instructions stored thereon, and one or more processors configured to execute the instructions and perform certain operations.

In some embodiments, the authentication system 100 includes a first user device 104 coupled to the authentication device 102 via a communication interface. In certain embodiments, the first user device 104 may be a computing device.

In some embodiments, the authentication device 102 receives, from the first user device 104, one or more attempts for authentication from a user 106. In certain embodiments, each attempt of the one or more attempts may include a request for entering a username and a password. In some embodiments, each attempt of the one or more attempts may include one or more different login schemes (e.g., username and password, biometrics, challenging questions, etc.) In some examples, the one or more processors of the authentication device 102 are configured to verify the username and password against records of stored usernames and passwords in the one or more memories. If the entered username and password does not match the stored record, the one or more processors are configured to decline the user’s attempt for authentication based on the entered username and password. In certain examples, attempts for authentication include biometric verifications (e.g., fingerprint, retina pattern, voice print, written signature). The one or more processors of the authentication device 102 are configured to decline one or more attempts for authentication up to a certain number as a preset limit. In some embodiments, the preset limit is five (5) attempts.

In some embodiments, after declining the one or more attempts for authentication, the one or more processors transmit a code 108 to the first user device 104. In certain examples, the code 108 is a one-dimensional code (e.g., barcode). In some examples, the code 108 is a two-dimension code. In certain examples, the code 108 is a multidimensional code. In some embodiments, the code 108 may be a quick reference (QR) code. In embodiments, the code contains the address (e.g., an URL) of a relevant service. In some embodiments, the one or more processors cause the first user device 104 to display the code 108. In some embodiments, the transmitted code 108 expires after a period of time being displayed on the first user device 104. For example, scanning the code 108 after a predetermined amount of time (e.g., 10 seconds) does not activate a preset action (e.g., accessing a website address for an authentication request).

In some embodiments, the first user device 104 is configured to submit one or more attempts for authentication to one or more processors (e.g., the one or more processors of the authentication device 102), receive declines of the one or more attempts from the one or more processors, receive the code 108 from the one or more processors, and displaying the code 108.

In some embodiments, the authentication system 100 further includes a second user device 110. The second user device 110 may be configured to scan the code 108 displayed by the first user device 104. In some embodiments, the second user device 110 transmits a scanned code to the one or more processors of the authentication device 102. In some embodiments, the code 108 has an embedded link that redirects to and opens up a URL (e.g., a unique URL) upon scanning the code 108. In some embodiments, scanning the code 108 leads to submitting an authentication request to the authentication device 102 and enables the authentication device 102 to retrieve one or more properties associated with the first user device 104 and/or the second user device 110. In some embodiments, scanning the code 108 enables the authentication device 102 to collect information about the user and/or other information that may be used in the authentication method. In some instances, the second user device 110 includes a camera configured to scan the code 108. In some instances, the second user device 110 may be a portable device including, for example, a mobile phone, a smartphone, a tablet computer, an e-reader, a personal digital assistant (PDA), or a watch, also connected to a wired/wireless network. As used herein, a portable device may be any device with a camera for acquiring images and a capacity to connect to a data transmission network.

In some instances, the second user device 110 may have an application installed on the device specifically configured to scan and launch the link embedded in the code. In some embodiments, the second user device 110 may be a smartphone with a camera application installed configured to recognize and scan codes (e.g., a QR code). In some instances, the second user device 110 may be a smartphone, and the application may be the camera application installed on the smartphone. In certain instances, the application on the second user device 110 includes an object recognition program configured to extract the scanned code from an image captured by the camera of the second user device 110. In some instances, the application on the second user device 110 is configured to conduct a preset action specified in the code (e.g., connect to a preset link embedded in the code).

In some embodiments, the one or more processors of the authentication device 102 are configured to receive an authentication request initiated by the second user device 110 scanning the code 108. In some embodiments, the one or more processors are configured to collect one or more properties associated with at least one selected from a group consisting of the first user device 104 and the second user device 110. In some instances, the first user device 104 is different from the second user device 110.

After collecting the one or more properties, for example, upon or after receiving the scanned code, the one or more processors are configured to evaluate an audit trail to generate an evaluation result, and to transmit a notification to the first user device 104 based at least in part on the evaluation result. In some instances, the one or more processors of the authentication device 102 are further configured to evaluate an audit trail 112 associated with at least one selected from a group consisting of the first user device 104 and the second user device 110.

In some embodiments, the audit trail 112 includes a plurality of verifications of one or more device properties. In certain embodiments, the audit trail 112 is activated and conducted by the authentication device 102 by an authentication request submitted from the first user device 104 or the second user device 110, for example, by pressing a button on a graphical user interface (GUI) on a respective device. In some embodiments, the audit trail 112 includes a plurality of verifications of one or more properties associated with the first user device 104 and/or the second user device 110. In some examples, the first user device 104 and/or the second user device 110 is identified as a trusted device, and the verifications are used to confirmation of the first user device 104 and/or the second user device 110. In certain examples, the audit trail 112 includes a plurality of verifications and requires a predetermined portion (e.g., 50%, 75%) of the plurality of verifications to be positive. In some examples, the audit trail 112 includes a plurality of verifications to be conducted sequentially, such that a negative verification causes an exit from the audit trail 112 with a negative evaluation result (e.g., fail).

In certain instances, the audit trail 112 includes user profile information (i.e., information found in the user’s profile on the back end of the system). Examples of a user profile information may include a unique user passcode for the user account. The user profile information may be used in addition to the plurality of verifications of one or more device properties.

According to certain embodiments, various components of the authentication system 100 can execute software or firmware stored in non-transitory computer-readable medium to implement various processing steps. Various components and processors of the authentication system 100 can be implemented by one or more computing devices, including but not limited to, circuits, a computer, a cloud-based processing unit, a processor, a processing unit, a microprocessor, a mobile computing device, and/or a tablet computer. In some cases, various components of the authentication system 100 (e.g., the authentication device 102, the first user device 104, the second user device 110) can be implemented on a shared computing device. Alternatively, a component of the authentication system 100 (e.g., the authentication device 102, the first user device 104, the second user device 110) can be implemented on multiple computing devices. In some implementations, various modules and components of the authentication system 100 can be implemented as software, hardware, firmware, or a combination thereof. In some cases, various components of the report data authentication system 100 can be implemented in software or firmware executed by a computing device.

The authentication device 102 may include a server such as at least one of a cloud server, and a virtual server that is hosted and delivered over a network that may be accessed on demand by multiple users. In embodiments, the authentication device 102 may be a physical server that is configured to store, send, receive data, and to perform aspects of embodiments of methods and procedures discussed herein. In some embodiments, the authentication device 102 may have an instance configured to run one or more web services that receive one or more authentication request from applications on the first user device 104 and/or the second user device 110, and communicate with application (e.g., responding to application requests, sending commands to applications, etc.)

The one or more memories includes computer-readable media in the form of volatile and/or nonvolatile memory, transitory and/or non-transitory storage media and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In some embodiments, the one or more memories store computer-executable instructions for causing a processor to implement aspects of embodiments of system components discussed herein and/or to perform aspects of embodiments of methods and procedures discussed herein.

In embodiments, the one or more memories of the authentication device 102 may store information such as user information (i.e. information known and unique to the user), user login credentials (e.g., username, user email, passwords, passcodes, etc.), a plurality of properties associated with user devices (e.g., internet protocol (IP) address, a device identification number, cached data, and a device type, phone number, an International Mobile Equipment Identity (IME1) number, a Mobile Equipment Identifier (MEID) number, and a phone model identification number, etc.), and other information associated with user or user device.

Computer-executable instructions may include, for example, computer code, machine-useable instructions, and the like such as, for example, program components capable of being executed by one or more processors associated with a computing device. Program components may be programmed using any number of different programming environments, including various languages, development kits, frameworks, and/or the like. Some or all of the functionality contemplated herein may also, or alternatively, be implemented in hardware and/or firmware.

In some embodiments, the memory may include a data repository implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

A computing device may include any type of computing device suitable for implementing embodiments of the disclosure. Examples of computing devices include specialized computing devices or general-purpose computing devices such as workstations, servers, laptops, portable devices (e.g., smartphones), desktop, tablet computers, hand-held devices, general-purpose graphics processing units (GPGPUs), and the like, all of which are contemplated within the scope of FIG. 1 with reference to various components of the authentication system 100.

In some embodiments, a computing device includes a bus that, directly and/or indirectly, couples the following devices: a processor, a memory, an input/output (I/O) port, an I/O component, and a power supply. Any number of additional components, different components, and/or combinations of components may also be included in the computing device. The bus represents what may be one or more busses (such as, for example, an address bus, data bus, or combination thereof). Similarly, in some embodiments, the computing device may include a number of processors, a number of memory components, a number of I/O ports, a number of I/O components, and/or a number of power supplies. Additionally, any number of these components, or combinations thereof, may be distributed and/or duplicated across a number of computing devices.

Various components of the authentication system 100 (e.g., the authentication device 102, the first user device 104, the second user device 110) can communicate via or be coupled to via a communication interface, for example, a wired or wireless interface. The communication interface includes, but not limited to, any wired or wireless short-range and long-range communication interfaces. The wired interface can use cables, umbilicals, and the like. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

The embodiment disclosed below is not intended to be exhaustive or limit the disclosure to the precise form disclosed in the following detailed description. Rather, the embodiment is chosen and described so that others skilled in the art may utilize its teachings.

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower-level programming language.

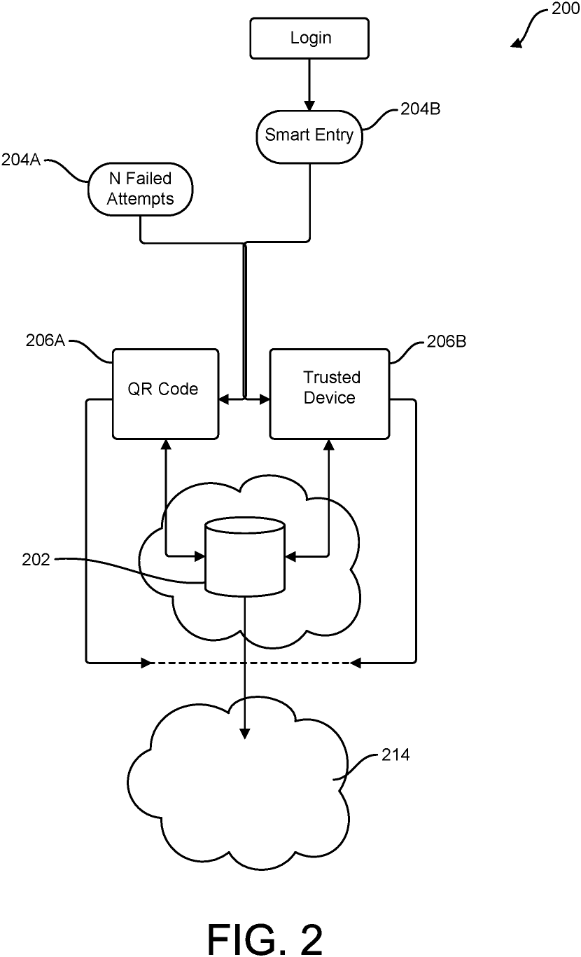

FIG. 2 is a simplified diagram illustrating a user authentication system 200 according to various embodiments. FIG. 2 is merely an example. One of ordinary skill in the art would recognize many variations, alternatives, and modifications. According to certain embodiments, the user authentication system 200 includes an authentication device 202, initial verification processors (e.g., software modules implemented on processors) 204A-B, and user selected secondary verification options 206A-B. Although the above has been shown using a selected group of components for the authentication system 200, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present disclosure.

As shown, the authentication system 200 includes an authentication device 202 having one or more memories having instructions stored thereon, and one or more processors configured to execute the instructions and perform operations. In some embodiments, the authentication device 202 may be a cloud server. In certain embodiments, the authentication device 202 may be a secured cloud server.

In some embodiments, the user authentication system 200 is configured to receive, and upon verifying, declining one or more attempts for authentication from a first user device (e.g., the first user device 104 in FIG. 1) in initial verification processor 204A. In some embodiments, the user authentication system 200 is configured to receive, from a first user device, a request for a smart entry in initial verification processor 204B, transmitting one or more questions about user information (i.e., information known and/or unique to the user or the user’s organization) to the first user device, and receiving and verifying the answer to the question before proceeding. In some embodiments, the one or more questions about unique user information is randomly selected from a plurality of questions associated with unique user information stored in the one or more memories. For example, the smart entry includes three (3) questions. As an example, the smart entry includes six (6) questions.

In some embodiments, the one or more processors of the user authentication system 200 are configured to, after the initial authentication step performed by processors 204A-B, request a selection from a user for verification option 206A or option 206B. Upon user selection of option 206A, the one or more processors of the user authentication system 200 are configured to transmit and cause the first user device to display a code (e.g., the code 108 in FIG. 1). In some instances, the code may have a unique Uniform Resource Locator (URL) embedded in the code. In some instances, in order to avoid the risk of codes being counterfeited, each generated code may be randomly selected from a plurality of codes stored in the one or more memories. The code may be scanned by a second user device, and upon scanning, redirects the second user device to the unique URL embedded in the code. A time limit may be imposed on the duration of the code being displayed on the first user device before being scanned by the second user device. If the code is not scanned by the second user device within the duration of the time limit, a different code may be generated. In some instances, the time limit may be about 10 seconds. In some instances, the time limit may be between 10 seconds to 60 seconds. In some instances, the time limit may be more than 60 seconds. Upon detecting the second user device reaching the unique URL, the one or more processors of the user authentication system 200 are configured to collect one or more properties associated with the second user device. Upon user selection of option 206B, the one or more processors of the user authentication system 200 are configured to direct the first user device to a unique URL. Upon detecting the first user device reaching the unique URL, the one or more processors of the user authentication system 200 are configured to then collect one or more properties associated with the first user device.

In some instances, after the first device (e.g., the first user device 104 in FIG. 1) accesses to the unique URL, the one or more processors of the user authentication system 200 are configured to set a time limit within which an evaluation result is generated based on the one or more properties collected. In some instances, the time limit may be about 10 seconds. In some instances, the time limit may be between 10 seconds to 60 seconds. In some instances, the time limit may be more than 60 seconds.

In some embodiments, the one or more processors of the authentication device 202 are further configured to evaluate an audit trail (e.g., the audit trail 112 in FIG. 1) associated with at least one selected from a group consisting of the first user device and the second user device. The audit trail may include one or more verifications of one or more properties associated with at least one selected from a group consisting of the first user device and the second user device. In embodiments, evaluating the audit trail includes comparing the one or more properties associated with at least one selected from a group of the first user device and the second user device to one or more property records stored in the one or more memories. In some embodiments, the evaluation result is further generated based on evaluating the audit trail.

In some instances, the one or more properties include a shared property of the first user device and the second user device. As used herein, a shared property is a property that can be collected about one or more user devices or used by one or more user devices. In some instances, the one or more properties include at least one selected from a group consisting of a first unique property of the first user device and a second unique property of the second user device. The one or more memories of the authentication device 202 may store one or more shared properties between the first user device and the second user device, a plurality of properties unique to the first user device, and a plurality of properties unique to the second user device. In embodiments, the one or more processors of the authentication device 202 is configured to randomly select one or more properties from the category of shared properties and collect the one or more selected shared properties from the user device reaching the unique URL. In embodiments, the one or more processors of the authentication device 202 is configured to randomly select one or more properties from the category of unique properties and collect the one or more selected unique properties from the user device reaching the unique URL.

In some embodiments, the one or more processors of the authentication device 202 are configured to receive a first verification information on the shared property of the first user device, and to evaluate the audit trail based on the first verification information. In some embodiments, the one or more processors of the authentication device 202 are configured to receive a second verification information on the shared property of the second user device, and to evaluate the audit trail based on the second verification information.

In some embodiments, the one or more processors of the authentication device 202 are configured to receive a third verification information on the first unique property of the first user device, and to evaluate the audit trail based on the third verification information.

In some instances, the one or more verifications include four or more verifications. The one or more processors of the authentication device 202 are configured to generate a positive evaluation result if at least a predetermined number of the one or more verifications are positive. In some embodiments, where the one or more verifications include four verifications, the one or more processors of the authentication device 202 are configured to generate a positive evaluation result if at least three of the four verifications are positive.

In some embodiments, when the one or more verifications are conducted in sequence, the one or more processors of the authentication device 202 are configured to generate a negative evaluation result if a current verification is negative. As used herein, “in sequence” is understood to mean the one or more processors of the authentication device 202 are configured to fail a verification sequence if the current one is negative, and to evaluate a subsequent verification information after evaluating the current verification being positive. In embodiments, if a first, second, and third verification information are evaluated to be correct, the one or more processors of the authentication device 202 are configured to generate a positive evaluation result. In embodiments, if one of the first, second, and third verification information is evaluated to be incorrect, the one or more processors of the authentication device 202 are configured to receive a fourth verification information on the second unique property of the first user device, and to evaluate the audit trail based on the fourth verification information.

In some embodiments, when a positive evaluation result is generated, the one or more processors of the authentication device 202 are configured to transmit a notification granting an access to the user. The authentication method may be used for accessing a secured system, server, site, network, or resource 214, In some instances, the authentication method may be used for accessing an information tracking system.

In some instances, the one or more processors of the authentication device 202 are configured to receive one or more properties associated with the first user device, and to evaluate an audit trail based on the one or more properties associated with the first user device.

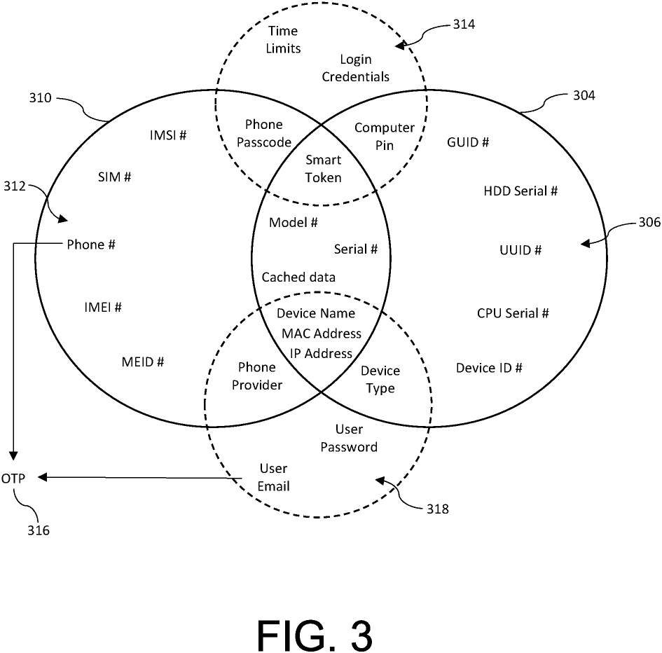

FIG. 3 illustrates properties associated with various user devices used for a user authentication method according to various embodiments. FIG. 3 is merely an example. One of ordinary skill in the art would recognize many variations, alternatives, and modifications.

In embodiments, a first user device 304 (e.g., the first user device 104 in FIG. 1) may be a computer. In some embodiments, the one or more properties 306 associated with a computer include at least one selected from a group consisting of a computer pin, a smart token, a device name, a media access control (MAC) address, an internet protocol (IP) address, a device identification number, cached data, a device type, a computer model number, a computer serial number, a globally unique identifier (GUID) number, a hard disk drives (HDD) serial number, a universally unique identifier (UUID) number, and a central processing unit (CPU) serial number. As shown, the computer pin and the smart token may be used for imposing access restrictions during the user authentication process; the device name, MAC address, IP address and device type are at relatively higher risk of being retrieved by a hacker. In some embodiments, as shown, the one or more properties 306 associated with a first user device further include one or more shared properties between the first user device and a second user device, and one or more unique properties that are uniquely associated with the first user device (e.g., a computer). In some embodiments, for example, smart token, model number, serial number, cached data, device name, MAC address, and IP address may be properties shared between the first user device and a second user device. In yet some embodiments, computer pin, GUID number, HDD serial number, UUID number, CPU serial number, device ID number, and device type may be properties unique to the first user device 304 (e.g., a computer).

In embodiments, the second user device 310 (e.g., the second user device 110 in FIG. 1) may be a phone. In some embodiments, the one or more properties 312 associated with a phone include at least one selected from a group consisting of a phone passcode, a smart token, a device name, a media access control (MAC) address, an internet protocol (IP) address, a phone provider, a phone number, an International Mobile Equipment Identity (IMEI) number, a Mobile Equipment Identifier (MEID) number, a phone model number, a phone serial number, cached data, an international mobile subscriber identity (IMSI) number, and a subscriber identity module (SIM) number. As shown, the phone passcode and smart token may be used for imposing access restrictions during the user authentication process; the device name, MAC address, IP address and phone provider are at relatively higher risk of being retrieved by a hacker. In some embodiments, as shown, the one or more properties associated with the second user device further include one or more shared properties between the first user device and a second user device, and one or more unique properties that are uniquely associated with the second user device. In some embodiments, for example, phone passcode, IMSI number, SIM number, phone number, IMEI number, MEID number, and phone provide may be properties unique to the second user device 310 (e.g., a phone).

In some embodiments, a group of properties 314 commonly used to impose access restrictions include phone passcode, smart token, login credentials, and/or computer pin during user authentication, and may also include imposing time limits (e.g., a unique link that expires after a time period), and verifying login credentials (e.g., user email, password, etc.). In certain embodiments, as user email and password are at relatively higher risk of being retrieved by a hacker, in certain embodiments, one or more processors of a user authentication system (e.g., the user authentication system 200) may be configured to generate a one-time passcode (OTP) 316 and send the OTP to a user via text based on the user’s phone number stored in the one or more memories, or via email based on the user’s email stored in the one or more memories.

In some embodiments, a group of properties 318 used to impose access restrictions may be relatively easy to obtain, and thus at a higher risk of being retrieved by a hacker. In some instances, properties that may be disguised include phone/computer device name, MAC address, IP address, phone provider, and user email. In certain instances, properties that are unique, but may be obtained by hackers include device type and user password. In some instances, cached data (e.g., browser) may be obtained by hackers as well. In certain embodiments, the user authentication system chooses properties that are not in the select group of properties 318, for example, easy to be retrieved, in the authentication process.

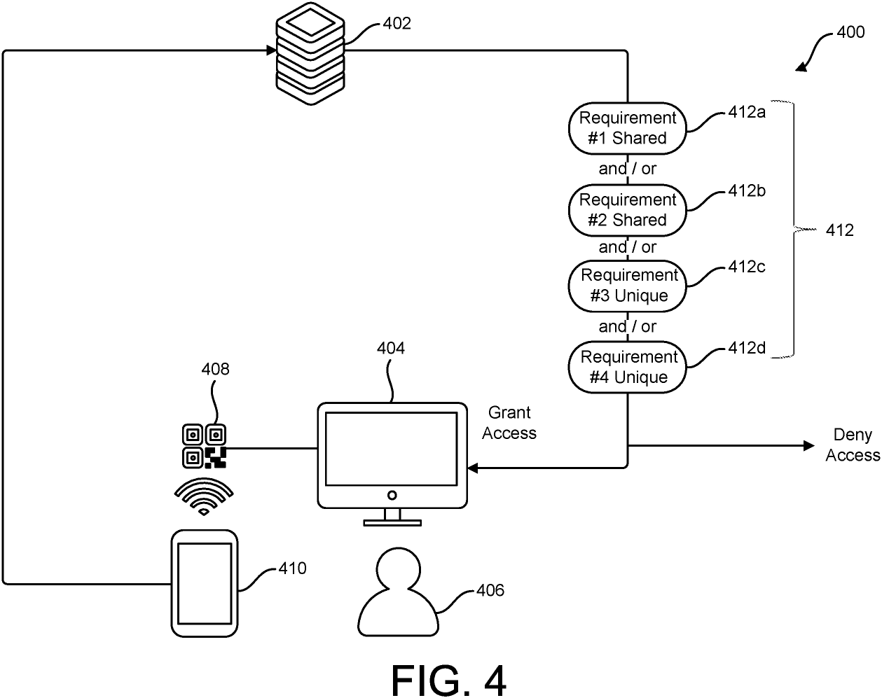

FIG. 4 illustrates a system diagram of a user authentication system 400 according to various embodiments. FIG. 4 is merely an example. One of ordinary skill in the art would recognize many variations, alternatives, and modifications. According to certain embodiments, the authentication system 400 includes an authentication device 402 including one or more memories (not illustrated) having instructions stored thereon, and one or more processors (not illustrated) configured to execute the instructions and perform certain operations. In some embodiments, the authentication system 400 includes a first user device 404 coupled to the authentication device 402 via a communication interface. In some embodiments, the first user device 404 may be a computing device. Although the above has been shown using a selected group of components for the authentication system 400, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some embodiments, the operations performed by the one or more processors of the user authentication system 400 include receiving, from a first user device 404, one or more attempts for authentication from a user 406. Each attempt of the one or more attempts may include a request for entering a username and a password. In some embodiments, the one or more processors of the user authentication system 400 are configured to verify the username and password against records of stored usernames and passwords in the one or more memories. If the entered username and password does not match the stored record, the one or more processors of the user authentication system 400 are configured to decline the user’s attempt to log in based on the entered username and password. The one or more processors of the user authentication system 400 are configured to decline one or more attempts for authentication up to a certain number as a preset limit. In some embodiments, the preset limit is 5 attempts.

In some embodiments, after declining one or more attempts for authentication, the one or more processors of the user authentication system 400 transmit a code 408 to the first user device 404. In some instances, the user may select an option for the one or more processors of the user authentication system 400 to transmit a code 408 to the first user device 404 without having to decline one or more attempts for authentication. In some embodiments, the code 408 may be a quick reference (QR) code. In some embodiments, the code contains the address of a specific resource on the Internet (e.g., a Uniform Resource Locator (URL)) of a relevant service. In some embodiments, the one or more processors of the user authentication system 400 cause the first user device 404 to display the code 408. In some embodiments, the transmitted code 408 expires after a period of time being displayed on the first user device 404 if not scanned.

In some embodiments, the first user device 404 is configured to submitting one or more attempts for authentication to one or more processors of the user authentication system 400, receiving declines of the one or more attempts from the one or more processors of the user authentication system 400, receiving a code 408 from the one or more processors of the user authentication system 400, and displaying the code 408.

In some embodiments, the authentication system 400 may further include a second user device 410. The second user device 410 may be configured to scan the code 408 displayed by the first user device 404, and redirected to open up a unique Uniform Resource Locator (URL) embedded in the code on the second user device 410. In some instances, the second user device 410 includes a camera configured to scan the code 408. In some instances, the second user device 410 may be a portable device including a mobile phone, a smartphone, a tablet, an e-reader, a personal digital assistant (PDA), or a watch, also connected to a wired/wireless network. As used herein, a portable device may be any device with a camera for acquiring images and a capacity to connect to a data transmission network.

In some instances, the second user device 410 may have an application installed on the device specifically configured to scan and launch the link embedded in the code. In some embodiments, the second user device 410 may be a smartphone with a camera application installed configured to recognize and scan codes (e.g., a QR code). In some instances, the second user device 410 may be a smartphone, and the application may be the camera application installed on the iPhone.

In some embodiments, the one or more processors of the user authentication system 400 are configured to detect the second user device 410 reaching a unique URL embedded in the code 408. In some instances, the first user device 404 is different from the second user device 410.

Upon detecting the second user device 410 reaching the unique URL, the one or more processors of the user authentication system 400 may be configured to collect one or more properties associated with the second user device 410, evaluate the one or more properties associated with the second user device 410 to generate an evaluation result, and transmit a notification to the first user device 404 based at least in part on the evaluation result. In some instances, the one or more processors of the user authentication system 400 are further configured to evaluate an audit trail 412 associated with at least one selected from a group consisting of the first user device 404 and the second user device 410.

In some embodiments, for example as shown in FIG. 4, the audit trail 412 may include four requirements 412a-d. In some instances, requirements 412a and 412b are shared properties. In some instances, requirements 412c and 412d are unique properties. In certain embodiments, requirements 412a-d include requirements not using one or more properties in a selected group of properties, for example, a group of properties easy to be retrieved, such as the properties 318 as illustrated in FIG. 3.

In some embodiments, when a positive evaluation result is generated, the one or more processors of the user authentication system 400 are configured to transmit a notification granting an access to the user. In some embodiments, when a negative evaluation result is generated, the one or more processors of the user authentication system 400 are configured to transmit a notification denying an access to the user. In some embodiments, the one or more processors of the user authentication system 400 are configured to deny access to a user after verifying requirement 412a. In some embodiments, the one or more processors are configured to deny access to a user after verifying requirement 412b, 412c, or 412d.

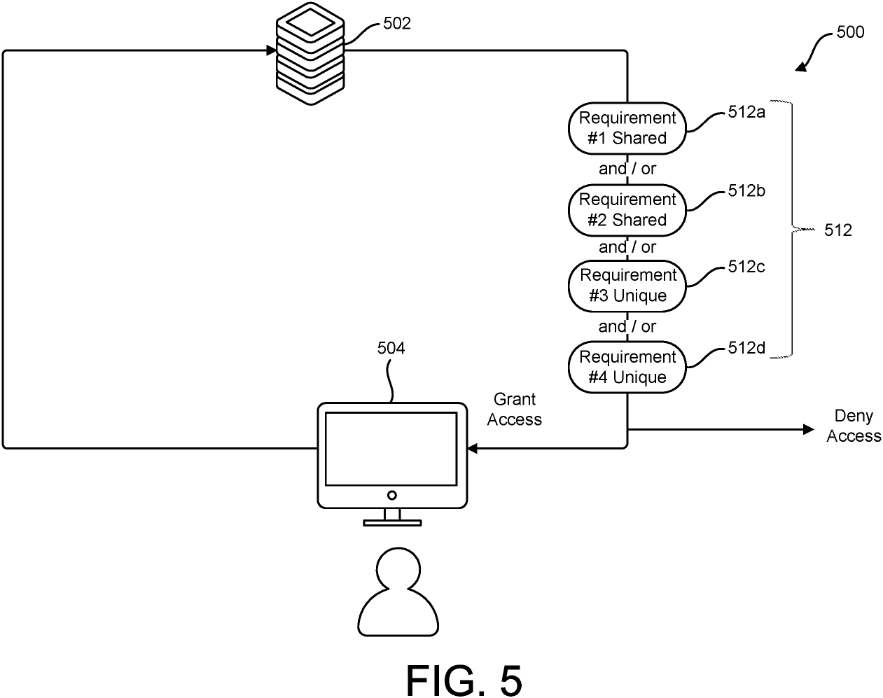

FIG. 5 illustrates a system diagram of a system 500 for user authentication according to various embodiments. FIG. 5 is merely an example. One of ordinary skill in the art would recognize many variations, alternatives, and modifications. According to certain embodiments, the system 500 includes an authentication device 502 including one or more memories (not illustrated) having instructions stored thereon, and one or more processors (not illustrated) configured to execute the instructions and perform certain operations. In some embodiments, the system 500 includes a first user device 504 coupled to the authentication device 502 via a communication interface. In some embodiments, the first user device 504 may be a computing device. Although the above has been shown using a selected group of components for the authentication system 200, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some instances, for example after a plurality of failed login attempts, the one or more processors of the system 500 are configured to request a selection from a user for either a “QR code” verification or “trusted device” verification. Upon user selection of “trusted device” verification (e.g., option 206B in FIG. 2), the one or more processors of the system 500 are configured to direct the first user device 504 to a unique URL. In some embodiments, the first user device 504 may not be a new device. In some embodiments, the first user device 504 is used at least once previously for user authentication and login to the secured system.

Upon detecting the first user device 504 reaching the unique URL, the one or more processors of the system 500 are configured to collect one or more properties associated with the first user device 504, evaluate the one or more properties associated with the first user device 504 to generate an evaluation result, and transmit a notification to the first user device 504 based at least in part on the evaluation result. In some instances, the one or more processors of the system 500 are further configured to evaluate an audit trail 512 associated with the first user device 504.

In some embodiments, for example as shown in FIG. 5, the audit trail 512 may include four requirements 512a-d. In some instances, requirements 512a and 512b are shared properties between the first user device 504 and a second user device (not illustrated here). In some instances, requirements 512c and 512d are properties that are unique to the first user device 504. In certain embodiments, requirements 412 a-d include requirements not using one or more properties in a selected group of properties, for example, a group of properties easy to be retrieved, such as the properties 318 as illustrated in FIG. 3.

In some embodiments, when a positive evaluation result is generated, the one or more processors of the system 500 are configured to transmit a notification granting an access to the user. In some embodiments, when a negative evaluation result is generated, the one or more processors of the system 500 are configured to transmit a notification denying an access to the user.

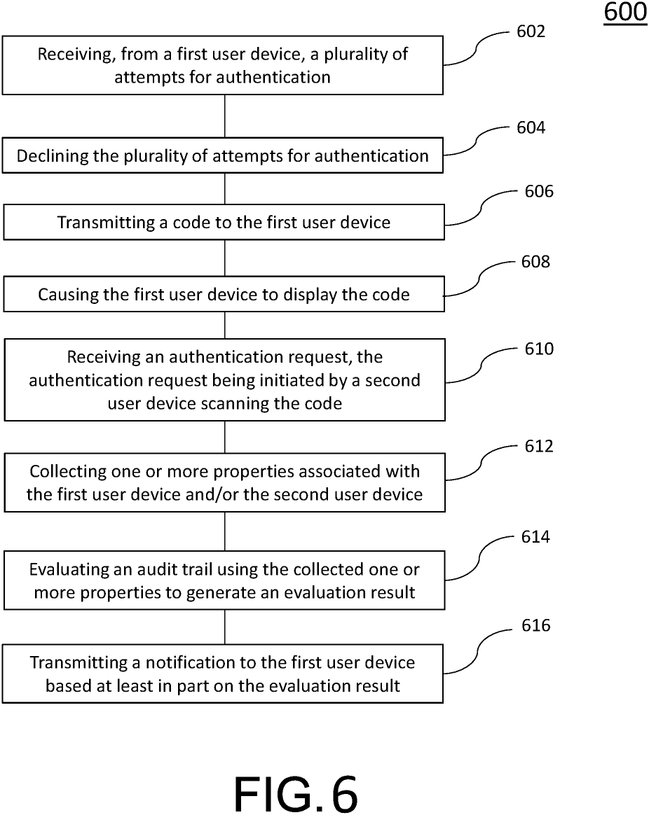

FIG. 6 illustrates a method 600 of authentication allowing one or more attempts, according to various embodiments. The method 600 may be implemented by a system including one or more processors and one or more memories. One or more steps of method 600 are optional and/or can be modified by one or more steps of other embodiments described herein. Additionally, one or more steps of other embodiments described herein may be added to the method.

At 602, the method 600 includes receiving, from a first user device (e.g., the first user device 104 in FIG. 1), one or more attempts for authentication, and, at 604, declining the one or more attempts for authentication. Each attempt of the one or more attempts may include a request for entering a username and a password. In some embodiments, the one or more processors are configured to verify the username and password against records of stored usernames and passwords in the one or more memories. If the entered username and password do not match the stored record, the one or more processors are configured to decline the user’s attempt to log in based on the entered username and password. The one or more processors are configured to decline one or more attempts for authentication up to a certain number as a preset limit. In some embodiments, the preset limit is 5 attempts.

At 606, the method 600 includes transmitting a code to the first user device, and, at 608, causing the first user device to display the code. In some embodiments, the code (e.g., the code 108 in FIG. 1) may be a quick reference (QR) code. In some embodiments, the code contains the address of a specific resource on the Internet (e.g., a Uniform Resource Locator (URL)) of a relevant service. In some embodiments, the transmitted code expires after a period of time being displayed on the first user device if not scanned.

At 610, the method 600 includes receiving an authentication request, the authentication request being initiated from a second user device (e.g., the second user device 110 in FIG. 1) scanning the code. In some embodiments, the second user device is different from the first user device. In some instances, the second user device includes a camera configured to scan the code. In some instances, the second user device may be a portable device including a mobile phone, a smartphone, a tablet, an e-reader, a personal digital assistant (PDA), or a watch, also connected to a wired/wireless network. As used herein, a portable device may be any device with a camera for acquiring images and a capacity to connect to a data transmission network.

At 612, the method 600 includes collecting one or more properties associated with at least one selected from a group consisting of the first user device and the second user device. In certain embodiments, the one or more properties do not include one or more properties in a selected group of properties, for example, a group of properties easy to be retrieved, such as the properties 318 as illustrated in FIG. 3.

At 614, the method 600 includes evaluating an audit trail using the collected one or more properties to generate an evaluation result.

At 616, the method 600 includes transmitting a notification to the first user device based at least in part on the evaluation result. In some instances, the one or more processors are further configured to evaluate an audit trail (e.g., the audit trail 112 in FIG. 1) associated with at least one selected from a group consisting of the first user device and the second user device.

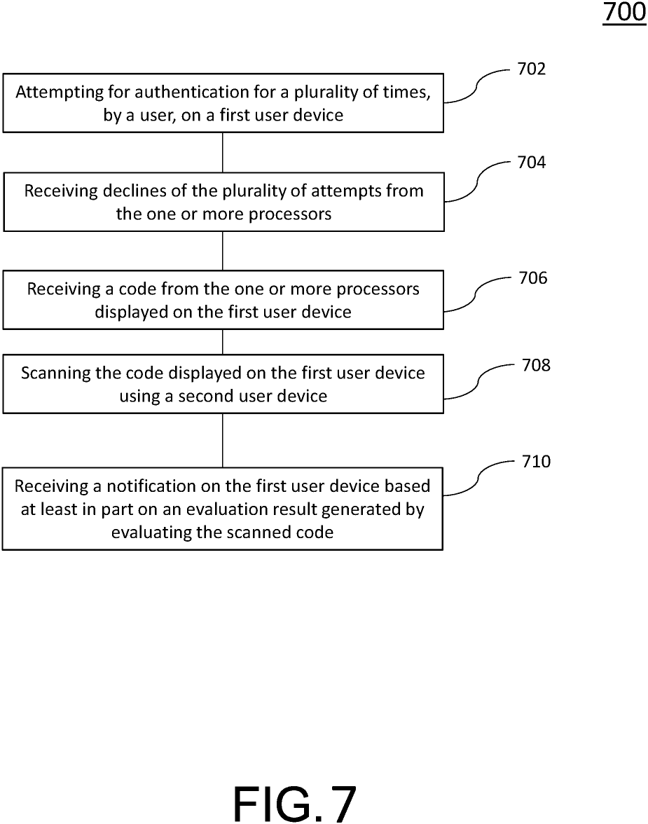

FIG. 7 illustrates a method 700 of authentication allowing one or more attempts, according to various embodiments. The method 700 may be implemented by a user using a system including one or more processors and one or more memories.

At 702, the method 700 includes attempting for authentication for a plurality of times, by a user, on a first user device (e.g., the first user device 104 in FIG. 1). The attempting for authentication may include typing in a username and password combination for verification, or a user email and password combination for verification.

At 704, the method 700 includes receiving declines of the one or more attempts from the one or more processors.

At 706, the method 700 includes receiving a code from the one or more processors displayed on the first user device. The code may be a QR code. In some embodiments, the code contains the address of a specific resource on the Internet (e.g., a Uniform Resource Locator (URL)) of a relevant service. In some embodiments, a transmitted code (e.g., the transmitted code 108 discussed in FIG. 1) expires after a period of time being displayed on a first user device (e.g., the first user device 104 in FIG. 1) if not scanned.

At 708, the method 700 includes scanning the code displayed on the first user device using a second user device (e.g., the second user device 110 in FIG. 1). In some embodiments, the second user device is different from the first user device. In some instances, the second user device includes a camera configured to scan the code. In some instances, the second user device may be a portable device including a mobile phone, a smartphone, a tablet, an e-reader, a personal digital assistant (PDA), or a watch, also connected to a wired/wireless network. As used herein, a portable device may be any device with a camera for acquiring images and a capacity to connect to a data transmission network.

At 710, the method 700 includes receiving a notification on the first user device based at least in part on an evaluation result generated by the one or more processors evaluating the scanned code. In some instances, the one or more processors are further configured to evaluate an audit trail (e.g., the audit trail 112 in FIG. 1) associated with at least one selected from a group consisting of the first user device and the second user device.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.”

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system comprising:
one or more memories having instructions stored thereon; and
one or more processors configured to execute the instructions and perform operations comprising:
receiving, from a first user device, one or more attempts for authentication;
declining the one or more attempts for authentication;
transmitting a code to the first user device;
causing the first user device to display the code;
receiving an authentication request, the authentication request being initiated by a second user device scanning the code, the second user device being different from the first user device;
collecting one or more properties associated with at least one selected from a group consisting of the first user device and the second user device;
evaluating an audit trail using the collected one or more properties to generate an evaluation result; and
transmitting a notification to the first user device based at least in part on the evaluation result.

2. The system of claim 1, further comprising:
receiving a scanned code from the second user device, the scanned code being generated by the second user device.

3. The system of claim 1, wherein the evaluating the audit trail comprises one or more verifications of one or more properties associated with at least one selected from a group consisting of the first user device and the second user device.

4. The system of claim 3, wherein the one or more properties comprise a shared property of the first user device and the second user device.

5. The system of claim 4, wherein the operations further comprise:
receiving a first verification information on the shared property of the first user device; and
evaluating the audit trail based on the first verification information.

6. The system of claim 4, wherein the operations further comprise:
receiving a second verification information on the shared property of the second user device; and
evaluating the audit trail based on the second verification information.

7. The system of claim 3, wherein the one or more properties comprise at least one selected from a group consisting of a first unique property of the first user device and a second unique property of the second user device.

8. The system of claim 7, wherein the operations further comprise:
receiving a third verification information on the first unique property of the first user device; and
evaluating the audit trail based on the third verification information.

9. The system of claim 3, wherein the one or more verifications comprise four or more verifications, wherein the operations further comprise generating a positive evaluation result if at least a predetermined number of the one or more verifications are positive.

10. The system of claim 9, wherein the one or more verifications are conducted in sequence, wherein the operations further comprise generating a negative evaluation result if a current verification is negative.

11. The system of claim 3, wherein the evaluating the audit trail comprises comparing the one or more properties associated with at least one selected from a group consisting of the first user device and the second user device to one or more property records stored in the one or more memories.

12. The system of claim 2, wherein the evaluation result is further generated based on evaluating the audit trail.

13. The system of claim 1, wherein the transmitted notification comprises granting an access if the evaluation result is positive.

14. The system of claim 1, wherein the operations further comprise:
receiving one or more properties associated with the first user device; and
evaluating an audit trail based on the one or more properties associated with the first user device.

15. The system of claim 14,
wherein the one or more properties associated with the first user device include at least one selected from a group consisting of an internet protocol (IP) address, a device identification number, cached data, and a device type.

16. The system of claim 14,
wherein the one or more properties associated with the first user device include at least one selected from a group consisting of a phone number, an International Mobile Equipment Identity (IMEI) number, a Mobile Equipment Identifier (MEID) number, and a phone model identification number.

17. The system of claim 1, wherein the transmitted code expires after a period of time.

18. The system of claim 1, wherein the code is a quick reference (QR) code.

19. The system of claim 1, wherein the second user device comprises a camera configured to scan the code.

20. The system of claim 1, wherein each attempt of the one or more attempts comprises a request for entering a username and a password.

21. The system of claim 1, wherein the code is randomly selected from a plurality of codes stored in the one or more memories.

22. The system of claim 1, wherein after receiving the scanned code, the one or more processors is configured to set a time limit within which the evaluation result is generated.

23. A system comprising:
one or more memories having instructions stored thereon; and
one or more processors configured to execute the instructions and perform operations comprising:
receiving, from a first user device, a request for smart entry;
granting the request for smart entry;
transmitting a code to the first user device;
causing the first user device to display the code;
receiving an authentication request, the authentication request being initiated by a second user device scanning the code, the second user device being different from the first user device;
collecting one or more properties associated with at least one selected from a group consisting of the first user device and the second user device;
evaluating an audit trail using the collected one or more properties to generate an evaluation result; and
transmitting a notification to the first user device based at least in part on the evaluation result.

24. The system of claim 23, wherein granting the request for smart entry comprises:
transmitting a question about user profile information to the first user device;
causing the first user device to display the question;
receiving an answer to the question; and
evaluate the answer based on user profile information stored in the one or more memories.

25. The system of claim 24, wherein the question about user profile information is randomly selected from a plurality of questions about user profile information.

26. A system comprising:
a first user device configured to:
submit one or more attempts for authentication to one or more processors;
receive declines of the one or more attempts from the one or more processors;
receive a code for authentication; and
display the code for authentication; and
a second user device configured to:
scanning the code displayed by the first user device;
in response to scanning the code, initiating an authentication request; and
submitting the authentication request to an authentication device;
wherein the authentication device is configured to evaluate an audit trail associated with the authentication request and generate an evaluation result;
wherein the first user device is configured to receive a notification indicative of the evaluation result;
wherein the first user device is different from the second user device.

27. The system of claim 26, wherein the second user device is further configured to:
generate a scanned code; and
submit the scanned code to one or more processors.

28. The system of claim 26, wherein the evaluating the audit trail comprises one or more verifications of one or more properties associated with at least one selected from a group consisting of the first user device and the second user device.

29. The system of claim 28, wherein the one or more properties comprise a shared property of the first user device and the second user device.

30. The system of claim 29, wherein the authentication device is configured to:
receive a first verification information on the shared property of the first user device; and
evaluate the audit trail based on the first verification information.

31. The system of claim 30, wherein the authentication device is further configured to:
receive a second verification information on the shared property of the second user device; and
evaluate the audit trail based on the second verification information.

32. The system of claim 28, wherein the one or more properties comprise at least one selected from a group consisting of a first unique property of the first user device and a second unique property of the second user device.

33. The system of claim 32, wherein the authentication device is configured to:
receive a third verification information on the first unique property of the first user device; and
evaluate the audit trail based on the third verification information.

34. The system of claim 28, wherein the one or more verifications comprises four or more verifications, wherein the authentication device is further configured to generate a positive evaluation result if at least a predetermined number of the one or more verifications are positive.

35. The system of claim 34, wherein the one or more verifications are conducted in sequence, wherein the authentication device is further configured to generate a negative evaluation result if a current verification is negative.

36. The system of claim 28, wherein the evaluating the audit trail comprises comparing the one or more properties associated with at least one selected from a group consisting of the first user device and the second user device to one or more property records stored in the one or more memories.

37. The system of claim 27, wherein the evaluation result is further generated based on evaluating the audit trail.

38. The system of claim 26, wherein the received notification comprises being granted an access if the evaluation result is positive.

39. The system of claim 26, wherein the authentication device is further configured to:
receive one or more properties associated with the first user device; and
evaluate an audit trail based on the one or more properties associated with the first user device.

40. The system of claim 39,
wherein the one or more properties associated with the first user device include at least one selected from a group consisting of an internet protocol (IP) address, a device identification number, cached data, and a device type.

41. The system of claim 39,
wherein the one or more properties associated with the first user device include at least one selected from a group consisting of a phone number, an International Mobile Equipment Identity (IMEI) number, a Mobile Equipment Identifier (MEID) number, and a phone model identification number.

42. The system of claim 26, wherein the displayed code expires after a period of time.

43. The system of claim 26, wherein the code is a quick reference (QR) code.

44. The system of claim 26, wherein the second user device comprises a camera configured to scan the code.

45. The system of claim 26, wherein each attempt of the one or more attempts comprises a request for entering a username and a password.

46. The system of claim 26, wherein the code is randomly selected from a plurality of codes stored in one or more memories of the authentication device.

47. The system of claim 26, wherein after receiving the scanned code, the one or more processors is configured to set a time limit within which the evaluation result is generated.

48. A method of authentication allowing one or more attempts, the method implemented by a system including one or more processors and one or more memories, the method comprising:
receiving, from a first user device, one or more attempts for authentication;
declining the one or more attempts for authentication;
transmitting a code to the first user device;
causing the first user device to display the code;
receiving an authentication request, the authentication request being initiated by a second user device scanning the code, the second user device being different from the first user device;
collecting one or more properties associated with at least one selected from a group consisting of the first user device and the second user device;
evaluating an audit trail using the collected one or more properties to generate an evaluation result; and
transmitting a notification to the first user device based at least in part on the evaluation result.

49. A method of authentication allowing one or more attempts, the method comprising:
submitting, by a first user device, one or more attempts for authentication;
receiving, by the first user device, declines to the one or more attempts;
receiving, by the first user device, a code for authentication;
displaying, by the first user device, the code for authentication;
scanning, by a second user device, the code displayed by the first user device;
in response to scanning the code, initiating, by the second user device, an authentication request; and
receiving, by the first user device, a notification indicating an evaluation result, wherein the evaluation result is generated by evaluating an audit trail associated with the authentication request;
wherein the first user device is different from the second user device.
